(19) United States
(12) Patent Application Publication
(10) Pub. No.: US 2018/0146354 A1
(43) Pub. Date: May 24, 2018

(54) SYSTEM AND METHOD FOR PROVIDING AUTOMATED PERSONAL SECURITY VIA A COMPUTING DEVICE

(71) Applicant: Bhumil Patel, Edmond, OK (US)

(72) Inventor: Bhumil Patel, Edmond, OK (US)

(21) Appl. No.: 15/818,175

(22) Filed: Nov. 20, 2017

Related U.S. Application Data
(60) Provisional application No. 62/424,701, filed on Nov. 21, 2016.

(51) Int. Cl. H04W 4/22; G06F 17/30; G06Q 50/26; G06Q 50/00

(52) U.S. Cl. CPC H04W 4/22; G06F 17/30864; G06F 17/30595; H04W 4/021; G06Q 50/265; G06Q 50/01; G06F 17/30241

(57) ABSTRACT

A system for providing personal security is disclosed. The system has a personal security module, including computer-executable code stored in non-volatile memory, a processor, and one or more location determination devices. The personal security module, the processor, and the one or more location determination devices are configured to receive first location data of an area of effect, receive second location data of one or more users, identify one or more affected users located within the area of effect by comparing the first location data to the second location data, and send notification data to each of the one or more affected users, the notification data instructing each of the one or more affected users to exit the area of effect.

### RELATED APPLICATIONS

This application claims the benefit of U.S. Provisional Patent Application Ser. No. 62/424,701, filed Nov. 21, 2016.

### FIELD OF THE INVENTION

The present invention relates generally to a system and method for automatically providing personal security and safety through the use of one or more mobile computing devices. More specifically, the invention relates to a system and method for monitoring, tracking, capturing and analyzing information about a user's location as well as events in the immediate vicinity of that user's location in order to alert not only the user, but also the user's identified contacts and emergency services personnel regarding the status and location of the user.

### BACKGROUND OF THE INVENTION

Many benefits are associated with a safety monitoring and reporting instrument when carried by an individual. The increase in frequent severe weather events and other unfortunate events such as mass shootings and other incidents of gun violence are on the rise. Under these circumstances, many people are facing challenging situations to make important decisions based on the information available to them. Most of the people who may be traveling are not aware of the events occurring in the area nearby or the area they are visiting until they either hear about such events on the radio or by watching the news. On the other hand, family members and friends may be unaware of the situation their loved ones may be facing.

In order to assist local meteorologists and television networks in providing accurate and timely weather reporting and forecasting, the National Weather Service (NWS) maintains a sophisticated network of radar installations throughout the United States. Each of the radar installations monitors the weather conditions within a given area, which is then reported to NWS. However, unless individuals are actively checking such information, it is difficult for any such individuals to be informed of or otherwise be made aware of events in their area.

Further, emergency assistance systems, such as 9-1-1 or similar systems in other countries, may provide assistance when a caller is in need of police, fire or other medical help. When a caller makes a call to an emergency assistance system for assistance, the operator asks for the nature of emergency, the name of the caller, and the address of the caller to verify the location shown and available to the operator on his or her system. Once the operator verifies the location and nature of emergency, the operator dispatches an appropriate unit to the location. Today, more than 70% of the emergency calls are made with cell phones where operators do not have an address of the caller available in a database. In these situations, the system requests the cellular tower location from the carrier for the approximate location of the caller. There have been instances where the emergency assistance system has failed due to an error in getting an accurate location of the caller. Sometimes the caller may be having health problems or other scenarios where the caller may not be to talk or call and notify the emergency assistance system.

Additionally, during and after severe weather or other disastrous events, the situation becomes worse for both individuals and emergency personnel, as it is more likely (due to overburdening of the system) that help does not reach victims in time. It also becomes difficult for first responders to evaluate and assess the situation without visiting the area where an incident occurs. Emergency assistance systems may provide assistance to citizens during these events, but such assistance systems are often down after such an event. If the emergency crews can evaluate the area of effect (area of the incident) and know how many people may need help before arriving to the scene, it may help them to allocate proper resources and provide quick assistance that may result in saving lives. However, there are no systems in place to currently allow for this to occur.

There are several shortcomings in the existing systems, and therefore there is a need in the art for systems and method that can improve safety monitoring and reporting. This information may be used to make decisions for emergencies (e.g., upcoming severe weather) and create an emergency action plan if evacuation is appropriate and to communicate with family and friends to provide notification in the case that people need help or to provide warning to avoid visiting an area where for example gun violence or mass shooting is in progress.

### SUMMARY OF THE INVENTION

In one aspect, the present invention is directed to a system for providing personal security. The system includes a personal security module, including computer-executable code stored in non-volatile memory, a processor, and one or more location determination devices. The personal security module, the processor, and the one or more location determination devices are configured to receive first location data of an area of effect, receive second location data of one or more users, identify one or more affected users located within the area of effect by comparing the first location data to the second location data, and send notification data to each of the one or more affected users, the notification data instructing each of the one or more affected users to exit the area of effect.

In another aspect, the present invention is directed to a method for providing personal security. The method includes receiving alert notification data at a personal security module, the alert notification data sent by a user via an input device. The method also includes retrieving location data of the user based on receiving the alert notification data and retrieving location data of an emergency responder based on the location data of the user. The method further includes establishing a communication link between the user and the emergency responder.

### BRIEF DESCRIPTION OF THE DRAWINGS

FIG. 1 illustrates a schematic overview of a computing device, in accordance with embodiments of the present invention;

FIG. 2 illustrates a schematic overview of a network, in accordance with embodiments of the present invention;

FIG. 3A illustrates a process flow of shelter check in identification after a user has received a severe weather alert or a life-threatening emergency alert; and

FIG. 3B illustrates a process flow for sending severe weather alerts to users located within an area of effect; and

FIG. 3C illustrates a process flow for estimating a status of a sheltered user according to an exemplary embodiment of the present invention;

FIG. 3D illustrates a process flow for monitoring and alerting users and their family members within an area of effect;

FIG. 4 illustrates a process flow for requesting help assistance and responding to assistance using for example a smartphone;

FIG. 5 illustrates a process flow for locating a nearest emergency responder from a requester's location and connecting them upon arrival;

FIG. 6 is a system diagram for a system for automatically providing personal security and safety through the use of one or more mobile computing devices, in accordance with an embodiment of the present invention; and

FIG. 7 is a schematic illustration of an exemplary embodiment of the present invention;

### DETAILED DESCRIPTION

The present invention relates generally to a system and method for automatically providing personal security and safety through the use of one or more mobile computing devices. More specifically, the invention relates to a system and method for monitoring, tracking, capturing and analyzing information about a user's location as well as events in the immediate vicinity of that user's location in order to alert not only the user, but also the user's identified contacts and emergency services personnel regarding the status and location of the user.

In the description above, the detailed description, the claims below, and in the accompanying drawings, reference is made to particular features (including method steps) of the various embodiments of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

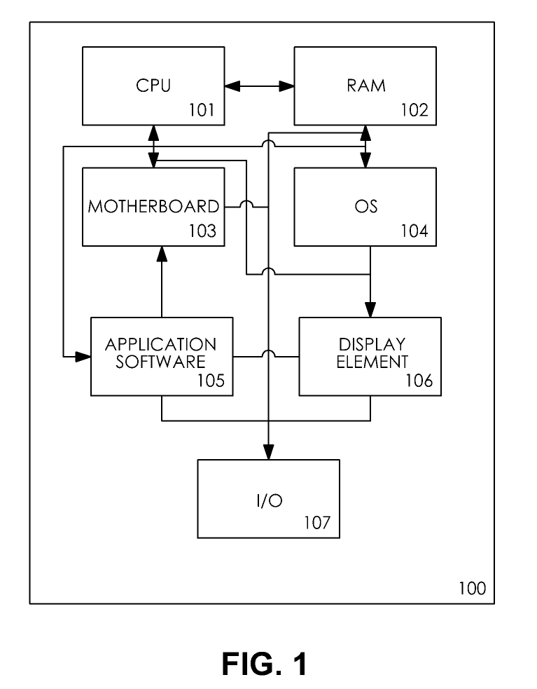

According to an embodiment of the present invention, the system and method may be configured to share with and/or receive data from one or more computing devices. As shown in FIG. 1, one of ordinary skill in the art would appreciate that a computing device 100 appropriate for use with embodiments of the present application may generally be comprised of one or more of the following: a central processing unit (CPU) 101, Random Access Memory (RAM) 102, a storage medium (e.g., hard disk drive, solid state drive, flash memory, cloud storage) 103, an operating system (OS) 104, one or more application software 105, one or more programming languages 106 and one or more input/output devices/means 107. Examples of computing devices usable with embodiments of the present invention include, but are not limited to, personal computers, smartphones, laptops, mobile computing devices, tablet PCs and servers. The term ‘computing device’ may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

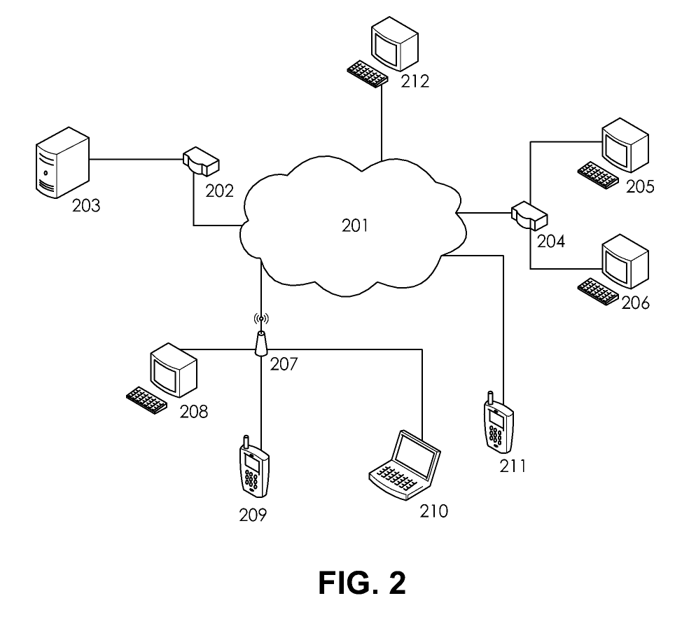

Referring to FIG. 2, a schematic overview of a cloud-based system in accordance with an embodiment of the present invention is shown. The cloud-based system is comprised of one or more servers 203 (e.g., application servers, database servers, and other servers) for computing, analyzing and electronically storing information used by the system. Applications in one or more of the servers 203 may retrieve and manipulate information in storage devices and exchange information through a Network 201 (e.g., the Internet, a LAN, WiFi, Bluetooth, etc.). Applications in server 203 may also be used to manipulate information stored remotely and process and analyze data stored remotely across a Network 201 (e.g., the Internet, a LAN, WiFi, Bluetooth, etc.).

According to an exemplary embodiment, as shown in FIG. 2, exchange of information through the Network 201 may occur through one or more high speed connections. High speed connections may be over-the-air (OTA), passed through networked systems, directly connected to one or more Networks 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to Network 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via Network 201 or other network in numerous ways. For instance, a component may connect to the system i) through a computing device 212 directly connected to the Network 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GSM, 3G, 4G) to the Network 201. One of ordinary skill in the art would appreciate that there are numerous ways that a component may connect to server 203 via Network 201, and embodiments of the present invention are contemplated for use with any method for connecting to server 203 via Network 201. Furthermore, the system could be comprised of a personal computing device, such as a smartphone, acting as a host for other computing devices to connect to.

With respect to the advantages of embodiments of the present invention, during severe weather or emergency situations or scenarios, wireless and cellular networks may be congested, making voice or other data heavy forms of communication difficult or impossible. In these scenarios, sending a text or notification via a mobile application works better as it takes less data and bandwidth than placing a call to notify or check in on your family members or other contacts.

According to an embodiment of the present invention, the system is configured to provide an integrated emergency assistance feature that allows users to quickly share accurate location of their whereabouts when the user needs assistance. The integrated emergency assistance feature may be capable of requesting appropriate emergency services, and in turn, the emergency service providers will be informed about the user's contact and location information to quickly assist when the user is not able to talk. In an exemplary embodiment, along with notifying emergency service providers (e.g., via a dispatch), the system may be configured to identify and notify appropriate emergency service providers in the area of a user of the emergency assistance request. In this manner, those closest to the user may be able to quickly respond to the request without first waiting for a centralized dispatch to transmit the request to all personnel in the area.

According to an embodiment of the present invention, the system is configured to use a location of the user's computing device (e.g., smartphone) or other location enabled device (e.g., GPS tracker) to determine the status and safety of the user's surroundings and inform the user's loved ones when the user is safe or needs help.

In an exemplary embodiment of the present invention, the system provides a method for a user to integrate an application component on a mobile computing device and verify certain information with the system in order to setup and allow the system to appropriately track the user's location and potentially the user's status (e.g., through sensors, such as a heart rate monitor on a smart watch or other device). The system also may provide the user the ability to send add requests other users to share and access locations with each other.

According to an embodiment of the present invention, the system provides a user the ability to request to let the user's computing device access their location, once user grants the system location access to the computing device, the system may utilize location information (e.g., GPS, Cellular triangulation) to identify the most accurate location of the user. With the use of the sensors within the mobile computing device of the user, the system is able to determine the movement of the user and if user is displaced more than a specified distance (e.g., 500 m) then the system is configured to fetch the location in the background and update it on the server or if a first user requests the location of a second user.

In exemplary embodiment of the present invention, users can share their location or access other user's location via their mobile computing devices by making API (Application Program Interface) requests or other similar requests to the system.

For example, in this exemplary embodiment, a first user can add a place to monitor to get notified when other users in the first user's group arrive or leave a place. When a user adds a place to monitor, the system can store (e.g., in a database or other data store) information related to the location, such as co-ordinates, and the mobile computing device of the user may keep track when other users in the group arrive or leave the monitored location. When a user arrives or leaves the monitored location then the mobile computing device sends a notification to the system which in turn sends a notification to the first user about the activity in that monitored location.

According to an embodiment of the present invention, the system is configured to fetch warnings, watches, alerts or other notifications issued by weather agencies and emergency services around the world and store the information. The system keeps track of the severe weather occurrences, or any emergency events occurring in areas users are located. If there is any severe weather developing or events occurring in the any area then users in that area are notified instantly and also user's family members and/or friends who are using the app are also notified that a given user is located in an affected area.

Once the user is notified and depending on the category and seriousness of the event the user will be prompted to take action accordingly that is recommended by a weather agency or emergency service agency or any other agency to either take shelter, evacuate the area or avoid entering the area and once the event time has passed then user will be prompted to see if they are safe or in need of help.

Further, the system can be configured to aggregate user data and present the aggregate data to emergency personnel, so that emergency personnel can best direct their resources (e.g., send personnel to affected areas with the most users in need of assistance based). Such aggregate user data can be utilized to build density or heat maps for the emergency personnel providers, allowing for visualization and development of appropriate response plans.

If the user is safe and updates the status as safe, the system may be configured to send notifications to (e.g., substantially all of) the friends and family of the user. Advantageously, friends and family will not need to call and check up on the user, and the user will not need to make numerous calls or other communications to check in with their friends and family. This also works to reduce stress on communications networks in times when demand is already destined to be high.

If a user needs help then the system may be configured to contact appropriate emergency contacts, and emergency contacts of the user may be notified. The notifications may include, for instance, the user's location and contact information.

The system may be further configured such that users can also request assistance via their mobile computing device. The system may then be provided the location of the user and the system may share this location and notify an appropriate emergency personnel dispatcher that user is in need of help. It is also contemplated that additional user information may be available (e.g., to first responders and other emergency personnel, upon request) via the system if permission is granted by the user. For example, data associated with personal health devices and other personal digital equipment may be available to the system in at least some exemplary embodiments. For example, in an emergency situation in which a user is believed to be for example in immediate danger or trapped under debris, additional data may be requested regarding the detailed status and/or detailed biometric data regarding that user (e.g., if requested by emergency personnel).

According to an embodiment of the present invention, the system may allow users to add private or public shelters (e.g., storm shelters) location and other information to be stored with the system. During emergencies (e.g., severe weather), users can notify emergency contacts or other users when they take shelter. Once the user notifies that they have taken shelter the system may fetch their current location and store it. In this manner, after the emergency is over, the location of the user can be shared with emergency services in case the user may be in the shelter or the shelter is covered with debris and get the assistance to the user quickly.

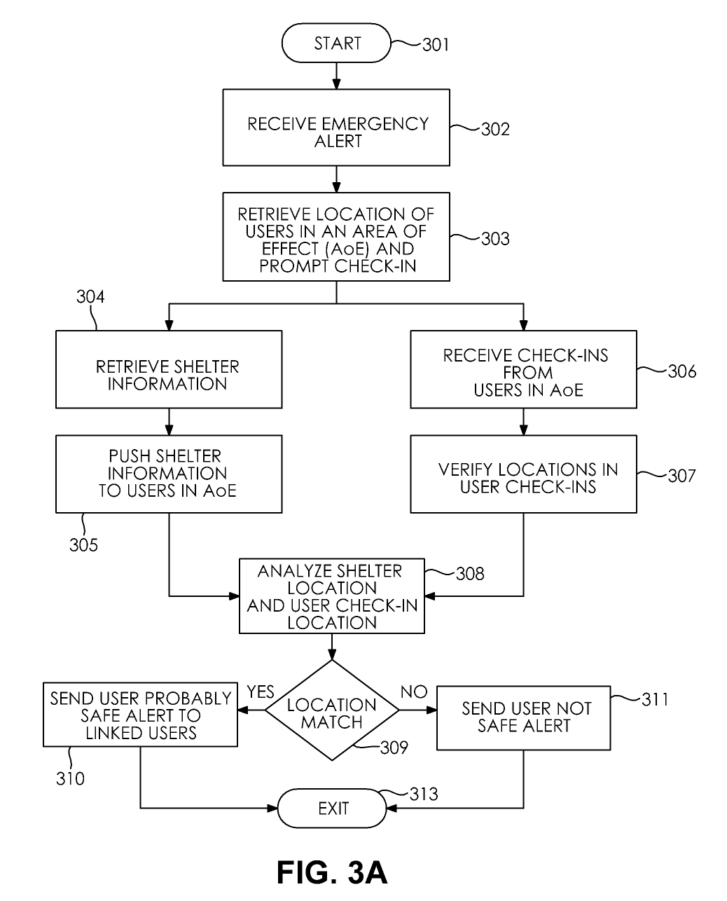

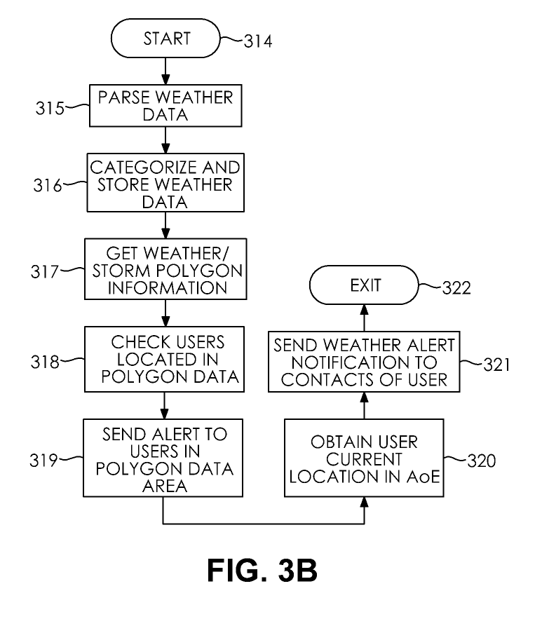

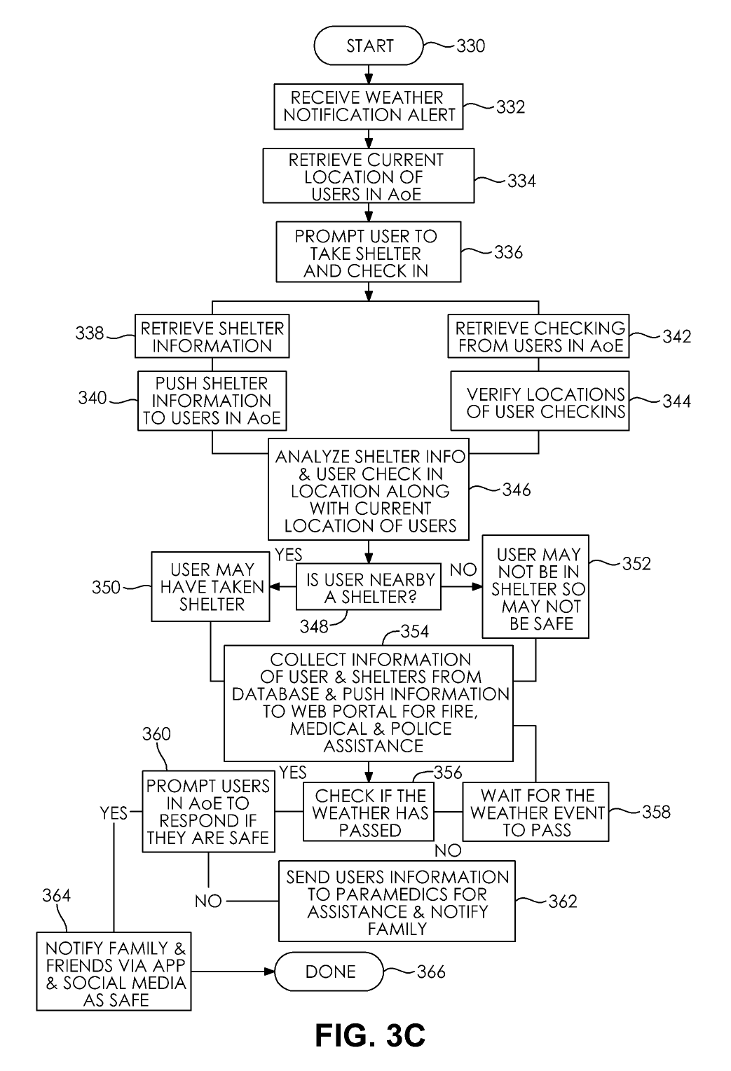

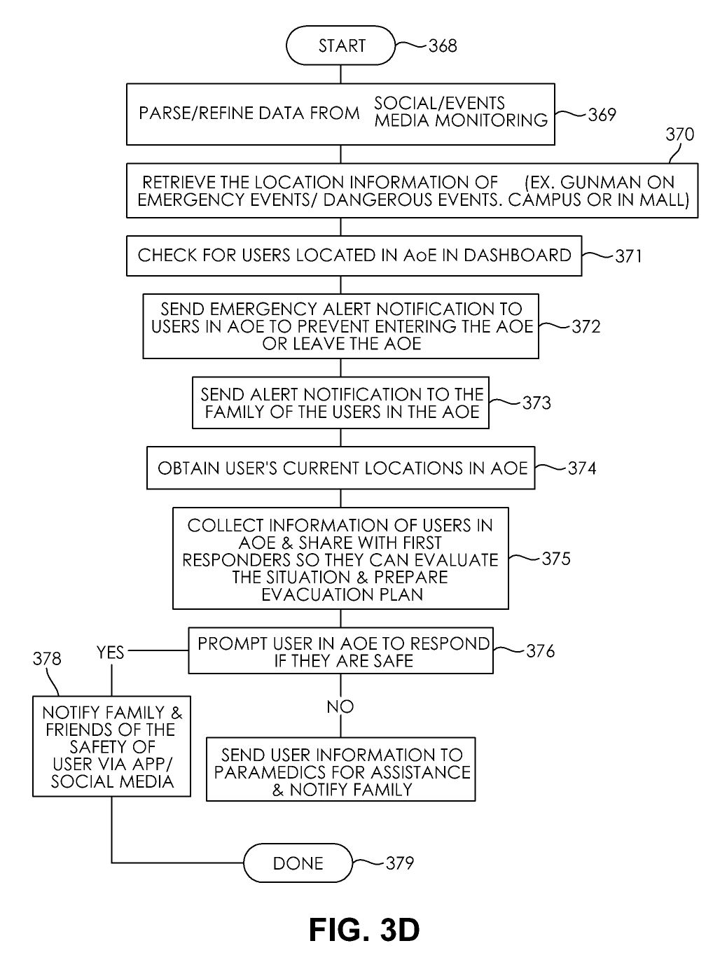

Turning now to FIG. 3A, a method in accordance with an exemplary embodiment of the present invention is shown. The process starts at step 301 with the system being engaged in response to an emergency alert. At step 302, the system receives and/or determines the emergency alert. The emergency alert could be provided, for instance from an emergency or weather alert service and received via an API. The emergency alert may also be based on automated monitoring of the system (e.g., similar the exemplary embodiment of FIG. 3D). For example, the system may run keyword queries and/or scans for events on social media sources. For example, when a comment (e.g., post, tweet, or other social media posting) is posted on social media, the exemplary system may identify the post based on keyword searching. For example, if the post includes a term used in the exemplary system's keyword searching, the social media post may be further analyzed by the system. For example, based on keyword searching, the system may further analyze posts containing search terms to evaluate the post to determine if there is a credible threat (e.g., likely threat, possible threat) in a given area based on the information contained in the social media post. The system alerts nearby users (e.g., users nearby a credible threat) for example in accordance with the exemplary embodiments disclosed herein. For example, an application programming interface (API) may be utilized to monitor third party media feeds (e.g., an API may provide data to the system). The exemplary system may synthesize, filter, and/or analyze such emergency data to produce an emergency alert to be sent out to users of the system. For example, monitoring of social media feeds by the exemplary system may be performed by a social feed monitoring subsystem of the exemplary system that locates threats and identifies threatening situations. Also for example, the social feed monitoring subsystem may validate social media feeds (e.g., validate posts and/or entire feeds as credible sources of information), and may notify users within an AoE based on the validated social media feeds.

At step 303, the system retrieves a current location of users in an area of effect (AoE) of the emergency. The system could utilize stored locations of last known locations of users, real-time or near real-time updates from computing devices associated with users, or any combination thereof. For users in the AoE of the emergency, the system may also be configured to issue or otherwise prompt users to check-in. A check-in may be sent, for instance, to a mobile computing device associated with the user via a push message or other notification. The check-in request may be directed at confirming the user's location and status (e.g., safe, not-safe).

At this point, the process could run parallel for one or more purposes. In a first operation, the system may retrieve shelter information regarding shelters near a user (step 304). Based on the last known location of the user, the system may retrieve viable options for the user to seek shelter based on known locations of shelter in the vicinity of the user.

At step 305, the system may push shelter information (or an alert to the user noting that shelters are available) to users in the identified AoE of the emergency event.

In a second (but generally parallel) operation, the system may receive check-ins from users in the AoE (step 306). The system may use check-ins from users and verify their locations and information about the safety of the user (step 307).

At step 308, the system may match the user's location with the location of one or more shelters to confirm whether the user is in a safe location or not (step 309).

If the user's location matches a known shelter location, even where the user has not sent a check-in, the system may be configured to send notifications to linked users that the user is likely safe, given their proximity to the shelter location (step 310). Of course, there is no guarantee without confirmation or other information provided from the user, it still may be useful to loved ones and other linked users to know that the user is likely safe. If the user is not near a shelter location, the system may identify the user is not in a safe area and take additional actions in that regard (step 311). Additional actions could include, for instance, contacting emergency personnel or other appropriate personnel and alert then that the user is in an unsafe area during the emergency alert period. At this point the process terminates at step 313. For example, the exemplary system may identify one or more users located in an emergency shelter and may send data of the one or more users located in the emergency shelter to an emergency responder (e.g., to a smartphone of an emergency responder).

Turning now to FIG. 3B, an exemplary process is shown related to processing of severe weather data. In this method, the process starts at step 314 with an ongoing process conducted by the system related to retrieval of weather data from an appropriate source, such as a third-party weather or emergency alert system, such as those that may be provided by weather agencies or government agencies and the system may retrieve this information, for example, by way of an application programming interface (API).

At step 315, the system parses the weather data provided by or retrieved from the weather system. In this manner, the system will convert the data received from the third party weather system into a format that may be consumed and processed by the system.

At step 316, the system categorizes and stores the weather data by criteria associated with the weather data. For example, criteria associated with the weather data may include, but is not limited to, urgency, severity, certainty, area, category and polygon (e.g., latitude and/or longitude data describing an area of effect, for example latitudinal and longitudinal coordinates defining a geographical area). The area of effect can be for example any geographical area affected by emergency conditions such as, for example, an area affected by a man-made disaster (e.g., mass shooting, a terrorist attack, an attack using weapons of mass destruction, or other emergency caused by intentional or unintentional human action) and/or a natural disaster (e.g., a flood, a tornado, an earthquake, severe weather, or any other natural phenomena creating emergency conditions). One of ordinary skill in the art would appreciate that there are numerous criteria that may apply and embodiments of the present invention are contemplated for use with any appropriate criteria.

At step 317, the system retrieves weather/storm polygon information from the retrieved weather data. At step 318, the system determines which users are located within the retrieved polygons.

At step 319, the system is configured to notify the users in the AoE (e.g., area of effect contained within a polygonal area or similarly defined geographic area). At step 320, the system obtains users current location in the AoE. At step 321, the system sends a notification to the family or other contacts of the user, noting the user is in the AoE. These notifications, both to the user and to the user's family or other contacts may not only identify that there is an alert, but can provide specific details about the alert, such as alert type (e.g., hurricane, tornado, tsunami), alert duration, expected severity, other criteria or aspects of the alert, or any combination thereof. At this point, the process may terminate or continue onto other methods provided by the system (step 322).

Turning now to FIG. 3C, a method in accordance with an exemplary embodiment of the present invention is shown. The process starts at step 330 with the system being engaged in response to an emergency alert. At step 332, the system receives a notification alert (e.g., a notification of severe weather or other natural disaster such as a flood or earthquake or a man-made disaster). The emergency alert could be provided, for instance from a weather alert service and received or pulled via an API. The notification alert may be warning of a manmade disaster such as, for example, a terrorist attack or a shooting incident.

At step 334, the system retrieves a current location of users in an area of effect (AoE) of the emergency, similar to the technique described above regarding FIG. 3A. At step 336, the system prompts the user to check in (e.g., provide appropriate data regarding, for example, status to the system). The system also prompts the user to take shelter. The system may also send natural disaster data to users within or nearby the AoE.

The user may then follow two processes in parallel. First at step 338, the system retrieves shelter information existing in the system (e.g., that has been already provided to the system). Shelter information may also be newly provided to the system by users or other entities (e.g., emergency responders or agencies). The data may include location data of one or more target locations (e.g., shelter locations) located within the area of effect. Such information may for example include a location of the shelter, capacity information, and/or status information of services provided at the shelter. At step 340, the system pushes shelter information to all users in the AoE. In parallel to steps 338 and 340, at step 342 the system retrieves check-ins from users in the AoE. At step 344, the system then verifies locations of user check-ins.

Based on the two parallel processes above, at step 346 the system analyzes shelter information and user check-in information (e.g., locations and other information). The system may update the analysis with updated user locations as such updates are received from users. At step 348, the system determines based on the above analysis whether a given user is nearby or within a given proximity of a shelter. If the system determines that the user is nearby a shelter, then the system updates the user status as probably or possibly having taken shelter at step 350. If the system determines that the user is not nearby a shelter, then the system updates the user status as probably or possibly not having taken shelter at step 352. For example, the system may identify one or more unprotected users located within the area of effect, the one or more unprotected users being located within the area of effect but outside of all of the one or more target locations (e.g., emergency shelters).

Based on the analysis of steps 350 and 352, the system at step 354 collects information of users and shelters per above from the database and pushes the information to a source such as, for example, a web portal. The web portal may be accessible to emergency agencies and other authorities, emergency personnel, and/or first responders such as, for example, firefighters, medical personnel, and police.

At step 356, the system determines based on information updates whether the severe weather has passed. If the severe weather has not passed, the system at step 358 repeats the previous steps (e.g., returns to step 354, or alternatively returns to an earlier step of the analysis such as, for example, step 348). If the severe weather (or other natural or man-made disaster) has passed, the system prompts users at step 360 to provide input indicating whether or not the users are safe. The user provides response data in response to prompting data from the system, the response data indicating whether or not the user is safe. If a user responds that the user is not safe (e.g., the user is unprotected), then the system at step 362 sends that user's information to an emergency responder (e.g., emergency personnel such as paramedics) for assistance. The system may also notify emergency contacts (e.g., as provided by the user or derived from other sources such as official records or social media sources), friends and/or family of the user's status (e.g., via social media sources or as identified by the user). If a user responds that the user is safe, then the system notifies friends and family of the user (e.g., via the application or other social media or notification method) at step 364 that the user is safe. At this point, the process terminates at step 366.

Turning now to FIG. 3D, a method in accordance with an exemplary embodiment of the present invention is shown. The process starts at step 368 with the system being engaged in response to an emergency alert. At step 369, the system receives data from an information source such as, for example, social media or an events monitoring source.

For example, the exemplary system may run a keyword-based query for social media such as twitter and facebook and also run a query on some twitter accounts such as @NWS, @NOAA, @USGSBigQuakes and any other suitable news outlets. The query may run at suitable time periods or intervals (e.g., every 30 seconds) for keywords such as, for example, #emergency #severe #shooting #tornado #hurricane. For example, if query results include results for recent tweets with the keywords of interest then the system checks for that keyword (or keywords) in other posts (e.g., tweets) across a given social media source (e.g., twitter) in the same geographic region. If the keyword results continue to surge, then the system may check in the area (e.g., geographic area) to validate and send (e.g., soft) notifications to users within that area (e.g., to notify users to watch out and to confirm the suspected threat identified based on the social media monitoring). Alternatively, the system may be subscribed to 3^{rd} party API services, which may send requests (e.g., a webhook request) to the system (e.g., the system's server) when any life-threatening events occur in an area being monitored by the system. Upon the received request (e.g., received webhook request), the system warns a user (e.g., and the user's family members and friends) about the warning in the area and prompts the user (e.g., and user's friends and family) for the user's safety status. The system may also operate similarly to as the exemplary system disclosed with respect to FIG. 3A.

At step 370, the system retrieves information (e.g., AoE location information and information describing the incident) regarding the extreme or emergency event. For example, the system may retrieve information that a shooter is active in a given location of a city such as a concert venue or a college campus (e.g., determined as the AoE).

At step 371, the system checks location information of users to determine users that are located in, near, or relatively nearby the AoE (e.g., determines whether one or more users are affected users, e.g., users affected by the emergency of AoE). Affected users may be directly and/or indirectly affected by the emergency occurring in the AoE. At step 372, the system sends an emergency alert notification (e.g., including pertinent information regarding the emergency) to users identified to be in, near, or relatively nearby the AoE. The system may issue varying levels of emergency alerts to various users based on a given user's proximity to the AoE. The system notifies users to leave or avoid the AoE.

At step 373, the system sends alert notifications to family and/or friends of the alerted users. At step 374, the system obtains users' current location in and nearby the AoE. At step 375, the system collects information of users in and/or nearby the AoE and pushes that information to authorities, emergency personnel, and first responders so that authorities may use the information to evaluate the situation and to organize and execute a response to the emergency. For example, authorities may use the information at step 375 to prepare evacuation plans. Also, for example, the system may send dispatch data to an emergency responder (e.g., located nearby a given user), the dispatch data instructing the emergency responder to go to the location of the user. The emergency responder may respond to the emergency assistance request using a smartphone.

At step 376, the system prompts users (e.g., sends prompting data) to provide input indicating whether or not the users are safe. The user may respond by sending response data indicating whether or not the one or more affected users is safe. If a user responds that the user is not safe, then the system at step 377 sends that user's information to emergency personnel (e.g., paramedics) for assistance. The system may send status data for the one or more affected users to an emergency personnel (e.g., an emergency responder) when the response data indicates that the one or more affected users is not safe. The system may also notify friends and/or family of the user. If a user responds that the user is safe, then the system notifies friends and family of the user (e.g., via the application or other social media or notification method) at step 378 that the user is safe. At this point, the process terminates at step 379.

As illustrated in FIG. 3D, a system for providing personal security may thereby be provided, the system including a personal security module, comprising computer-executable code stored in non-volatile memory, a processor, and one or more location determination devices (e.g., as illustrated for example in FIGS. 1, 2, and 6-10). The personal security module, the processor, and the one or more location determination devices may receive first location data of an AoE (e.g., step 370) and receive second location data of one or more users. The system may identify one or more affected users located within the area of effect by comparing the first location data to the second location data. The system may send notification data to each of the one or more affected users, the notification data instructing each of the one or more affected users to exit the AoE (e.g., step 372).

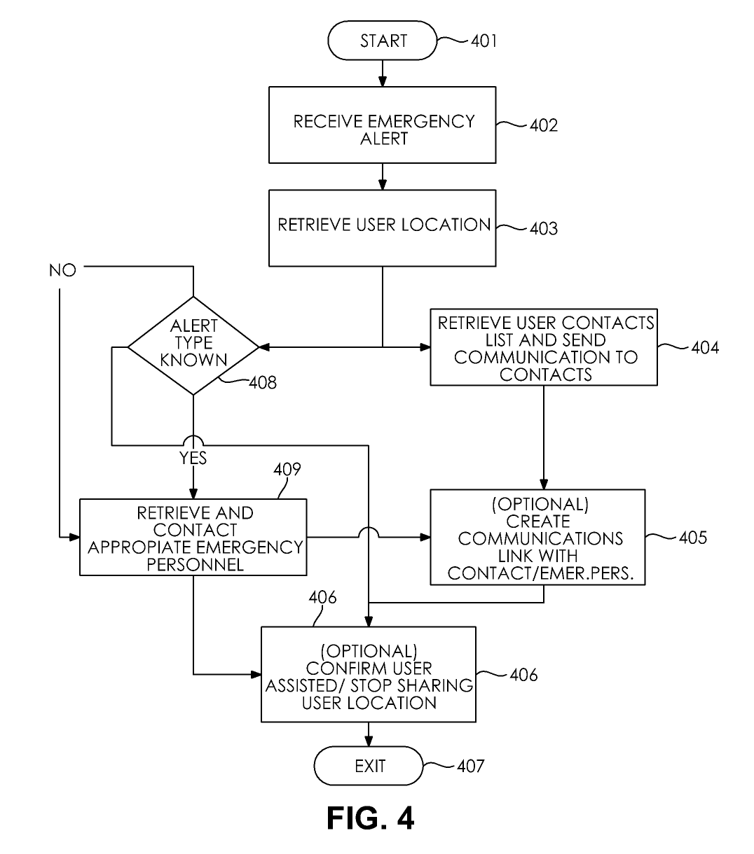

Turning now to FIG. 4, a method in accordance with an exemplary embodiment of the present invention is shown. The process starts at step 401 with the system being engaged in response to an emergency alert from a user. At step 402, the system receives the emergency assistance alert from a requester (e.g., a user). The user emergency alert is provided when a user is in danger or is otherwise in need of assistance.

At step 403, the system retrieves the user location, either through communication with a computing device associated with the user, or as retrieved from the user emergency alert as originally provided. The location may also be continuously updated as time goes on to ensure accurate tracking of the user's location. Other information may also be retrieved or associated with the alert, such as information provided from sensors associated with the computing device (e.g., heart rate, movement, text communication, video).

At step 404, the system retrieves a contact list associated with the user and sends communications to those contacts. In parallel, the system may also determine if the emergency alert identifies a known alert type. If the alert type is known at step 408, the system can identify the appropriate emergency personnel to contact (e.g., medical, police, and/or fire department) and send the alert information to those emergency personnel (step 409). If the alert type is not known, the system could be configured to send the alert to various emergency personnel for processing and routing appropriately. Otherwise, the system may ignore the portion of the method that revolves around contacting emergency personnel.

In some embodiments, the system will be configured to create a communications link between one or more of the user, emergency personnel, contacts associated with the user, or any combination thereof (step 405). Further, in some embodiments, the system may be configured to confirm the user was assisted, and once it is confirmed the user has received assistance, the system can automatically be configured to discontinue sharing of the user's location (step 406). At this point, the process will terminate at step 407.

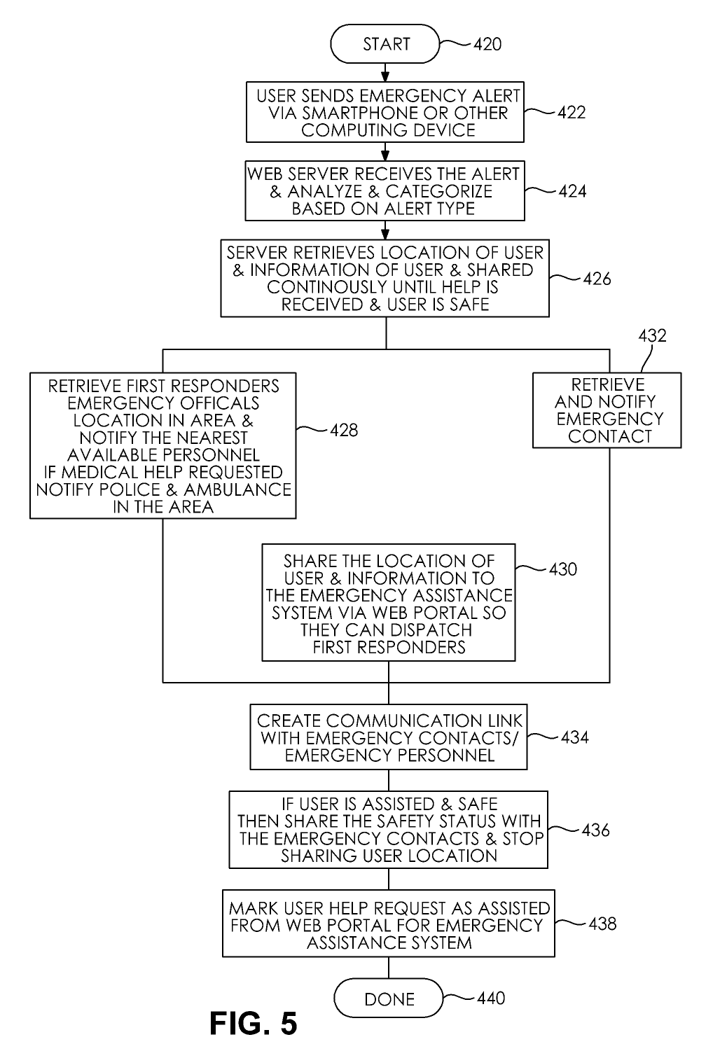

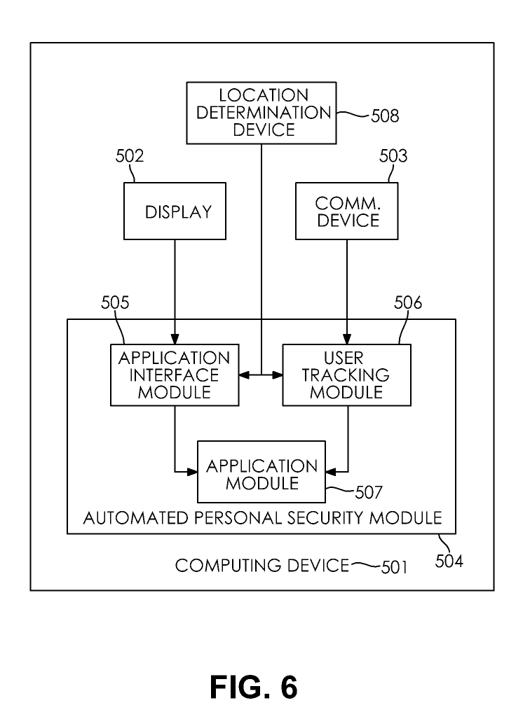

Turning now to FIG. 5, a method in accordance with an exemplary embodiment of the present invention is shown. The process starts at step 420 with the system being engaged in response to an emergency. At step 422, a user sends an emergency alert via any suitable computing device (e.g., a smartphone and/or a device having components of FIG. 1, FIG. 2, and/or FIG. 6 such as an input device and/or other computing device components). For example, the alert notification data being sent by the user may be sent via smart-phone. Also, the data may be sent via a non-telephone-call transmission (e.g., not transmitted as a phone call). For example, the user may send the data via a non-voice transmission from his or her smartphone to the system (e.g., by non-voice data transmission as disclosed in FIG. 2).

At step 424, the system receives the alert (e.g., via a web server receiving the alert). The alert is analyzed (e.g., to determine the type of alert) and categorized based on the type of alert. At step 426, the system (e.g., a server of the exemplary system or other component associated with the system) retrieves location information of the user and any other suitable information stored by the system regarding the user. The system may communicate continuously with the user and continuously update information associated with the user (e.g., location information) until help is received and the user is safe as disclosed in at least some exemplary embodiments disclosed herein. At this point, the system may perform several processes (e.g., step 428, step 430, and step 432 in parallel.

At step 428, the system retrieves location and/or status information of first responders (e.g., emergency personnel and other emergency officials) and notifies emergency personnel having locations nearby the user. For example, if medical help is requested by the user, nearby police and paramedics are notified by the system.

At step 430, location and other information of the user (e.g., status information) may be shared via an information source that authorities and emergency personnel can access. For example, the system may provide user information to a web portal or other source available to an emergency responder (e.g., emergency personnel). Based on the information provided by the exemplary system, emergency personnel may dispatch first responders (e.g., personnel located nearby the user) to the user's location.

At step 432, the system retrieves the emergency contacts of the users (e.g., contact information of family members and friends of the user that may be previously provided by the user and/or provided by the user at step 432 based on prompting from the system). The system notifies the emergency contacts of the user of the emergency alert.

Based steps 428, 430, and/or 432, the system creates a communication link at step 434. The communication link may be between emergency personnel, emergency contacts of the user, and/or the user. For example, a communication link may be established between the user and an emergency responder and/or emergency contact. Also for example, the communication link may be established between the user and one or the emergency responder and an emergency contact, and then subsequently the other of the emergency responder and the emergency contact may be added to the link. For example, if the user becomes incapacitated during an emergency in the AoE, the emergency responder could continue to communicate with the emergency contact to obtain information useful in creating a safe situation for the user. The communication link may be made using any suitable method of communication, for example as the communication techniques set forth above in FIG. 2. For example, the communication link may be a direct communication link made via internet, telephone, or any other suitable communication method. Also for example, network-less communication (e.g., communication not utilizing a network) may be used in forming the communication link. For example, mesh networking may be used in establishing the communication link. For example, mesh networking may be established based on a plurality of users utilizing WiFi, Bluetooth, and/or similar communications devices. For example, the communication link may be formed based on a plurality of users (e.g., several, about 5, about 10, or many users such as 50 or 100 or more users) using WiFi, Bluetooth, and/or similar devices, with messages being transmitted via adjacent user devices. For example, messages between various users may be transmitted via adjacent users (e.g., “bouncing off” of adjacent users) to form a networking mesh. Accordingly, one or more users, emergency responders, and/or contacts of users may communicate with each other through such a mesh networking technique. For example, the communication link may be a non-internet BLE (Bluetooth Low Energy) mesh networking communication link (e.g., a mesh network established by BLE devices that are not communicating via internet). Accordingly, for example, the communication link may be a mesh networking communication link. Information suitable for resolving the emergency may be exchanged between the various parties.

At step 436 (and similarly to as further described herein for at least some exemplary embodiments), if the user has been assisted and is in a safe condition (e.g., based on response data provided by a user in response to prompting data from the system), the system shares the safe status with the emergency contacts. The system may also end the communication link of step 434.

At step 438, the system may note or mark the user emergency alert request as having been addressed (user having been assisted) on the information source accessible by emergency personnel (e.g., web portal). At this point, the process will terminate at step 440.

FIG. 6 illustrates a system diagram for a system for automatically providing personal security and safety, including a computing device 501. Computing device 501 may have components similar to those described above in relation to FIG. 1 and FIG. 2. Computing device 501 may include an automated personal security module 504 that includes an application interface module 505 that provides an interface to a user or other personnel via a display 502. Automated personal security module 504 may also include a user tracking module 506 for tracking a user, that may operate in tandem with a communication device 503 (e.g., such as a transceiver and/or responder). Computing device 501 may also include a location determination device 508 (e.g., components of a positioning system that operate with a global positioning system to provide location information associated with computing device 501). Location determination device 508 may operate in tandem with an operation of application interface module 505 and user tracking module 506, and application interface module 505 and user tracking module 506 may operate with an application module 507, to provide information and execute processes for use in the exemplary disclosed system and method described herein.

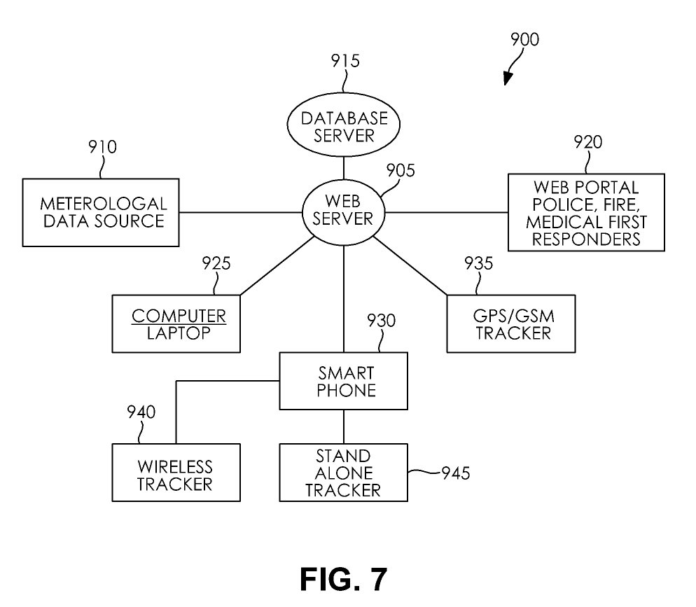

Further to the exemplary embodiments shown in FIG. 2, FIG. 7 illustrates a computer system 900 that may be used with the exemplary disclosed system and method. Computer system 900 may include a web server 905 that may operate in communication with a meteorological data source 910 (or similar emergency information source for natural or man-made disasters), a database server 915, a web portal 920, and a plurality of devices 925, 930, and/or 935. Web server 905 may exchange weather data with meteorological data source 910 and various information (e.g., as disclosed in at least some of the exemplary embodiments herein) with database server 915 (e.g., exemplary system server). Emergency personnel such as police, firefighters, and medical first responders may access information of the exemplary system via web portal 920. Plurality of devices 925, 930, and 935 may include any suitable devices such as, for example, a computer or laptop (e.g., of a user) accessing web server 905, a smartphone accessing web server 905 via any suitable technique (e.g., CDMA, GSM, 3G, 4G, and/or LTE), and/or a GPS/GSM tracker accessing web server 905 via any suitable technique (e.g., CDMA, GSM, 3G, 4G, and/or LTE). A plurality of devices 940 and 945 (e.g., a wireless tracker and/or a stand-alone tracker connected via Bluetooth or any other suitable protocols) may be in operable communication with devices 925, 930, and/or 935.

Embodiments of the present invention may be generally used as safety and security tool for families and its members. Other embodiments of the present invention may be utilized in commercial sectors where it may be used by businesses, organizations and institutions to monitor, locate and stay informed on the status of their employees, personnel or students when they are on a business trip, field trip, or on the road and the organization is responsible for their safety.

According to an embodiment of the present invention, the system may be further configured to be used as an analysis tool for emergency events and track how many people may be in affected area and get quick reports on the situation from the users in the affected area.

In certain embodiments, a GPS tracker will also be used as telematics for tracking vehicles for fleet tracking as customized applications for businesses or insurance companies for their customers to provide better rates for safe driving. A GPS tracker can further be used by parents to monitor their child when they go to school so they know if their child leaves the school premises.

In at least some exemplary embodiments, users can quickly share the location and request assistance without the need of placing a phone call that consumes more bandwidth, but instead the same information can be shared with the operator or first responders nearby with the use of this system by sending an alert via smartphone or other computing device. For example, when the person enters the storm shelter in the path of oncoming tornado, after the event the person may be stuck under the debris and may need quick assistance to get out of the area before flood waters rush in or the person may not be able to notify that they have taken shelter (and in this case the first responders may not know his presence in the shelter if the person has not registered the storm shelter with city).

The exemplary system and method disclosed herein may be used with and/or integrated into any suitable existing automated communication system or network. The exemplary system and method may provide safety information to emergency personnel in any suitable geographical region via existing communication infrastructure. It is also contemplated that newly built communication infrastructure may be designed and built to facilitate the operation of the exemplary disclosed system and method.

The exemplary disclosed system and method may provide user data that may assist emergency personnel such as first responders in assisting users in the case of emergency. The exemplary system and method may also notify users of events and locations of incidents to avoid, such as mass shootings and/or severe weather. The exemplary system and method may also aggregate user data to aid agencies and authorities in organizing and executing responses to extreme events, as well as facilitating decision-making by authorities in deploying resources in the case of severe events. The exemplary disclosed system and method may also provide an efficient technique for transferring information, which may reduce stress on communication systems which are often burdened during extreme events (e.g., avoiding excessive amounts of phone calls being made to check on family and friends during emergencies). By providing an efficient and low-bandwidth technique for updating users, friends, families, first responders, and authorities as to status of people affected by extreme events, the exemplary disclosed system and method may provide effective communication during emergencies.

Traditionally, a computer program consists of a finite sequence of computational instructions or program instructions. It will be appreciated that a programmable apparatus (e.g., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In an exemplary embodiment of the present invention, the data store may be a relational database, working in conjunction with a relational database management system (RDBMS) for receiving, processing and storing data. In an exemplary embodiment, the data store may comprise one or more databases for storing information related to the processing of moving information and estimate information as well one or more databases configured for storage and retrieval of moving information and estimate information.

Computer program instructions such as those required to operate the software component of the present invention can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Python, Perl, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The suitable structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

While multiple embodiments are disclosed, still other embodiments of the present invention will become apparent to those skilled in the art from this detailed description. There may be aspects of this invention that may be practiced without the implementation of some features as they are described. It should be understood that some details have not been described in detail in order to not unnecessarily obscure focus of the invention. The invention is capable of myriad modifications in various obvious aspects, all without departing from the spirit and scope of the present invention. Accordingly, the drawings and descriptions are to be regarded as illustrative in nature and not restrictive.

Insofar as the description above and the accompanying drawings disclose any additional subject matter that is not within the scope of the claims below, the inventions are not dedicated to the public and the right to file one or more applications to claim such additional inventions is reserved.

It will be apparent to those skilled in the art that various modifications and variations can be made to the disclosed system and method. Other embodiments will be apparent to those skilled in the art from consideration of the specification and practice of the disclosed system and method. It is intended that the specification and examples be considered as exemplary only, with a true scope being indicated by the following claims and their equivalents.

1. A system for providing personal security, the system comprising:
a personal security module, comprising computer-executable code stored in non-volatile memory;
a processor; and
one or more location determination devices;
wherein the personal security module, the processor, and the one or more location determination devices are configured to:
receive first location data of an area of effect;
receive second location data of one or more users;
identify one or more affected users located within the area of effect by comparing the first location data to the second location data; and
send notification data to each of the one or more affected users, the notification data instructing each of the one or more affected users to exit the area of effect.

2. The system of claim 1, wherein the notification data includes data based on a monitoring of a social media feed by the system.

3. The system of claim 1, further comprising sending dispatch data to an emergency responder, the dispatch data instructing the emergency responder to go to the location of the one or more users.

4. The system of claim 3, wherein the emergency responder responds to the dispatch data, which is an emergency assistance request, using a smartphone.

5. The system of claim 2, wherein the monitoring of the social media feed by the system is performed by a social feed monitoring subsystem of the system that locates threats and identifies threatening situations.

6. The system of claim 1, wherein the personal security module, the processor, and the one or more location determination devices are configured to send prompting data to the one or more affected users.

7. The system of claim 6, wherein the personal security module, the processor, and the one or more location determination devices are configured to receive response data from the one or more affected users in response to the prompting data, the response data indicating whether or not the one or more affected users is safe.

8. The system of claim 7, wherein the personal security module, the processor, and the one or more location determination devices are configured to send status data for the one or more affected users to an emergency responder when the response data indicates that the one or more affected users is not safe.

9. The system of claim 5, wherein the social feed monitoring subsystem validates social media feeds and notifies affected users based on the validated social media feeds.

10. A system for providing personal security, the system comprising:
a personal security module, comprising computer-executable code stored in non-volatile memory;
a processor; and
one or more location determination devices;
wherein the personal security module, the processor, and the one or more location determination devices are configured to:
receive first location data of an area of effect;
receive second location data of one or more users;
receive third location data of one or more target locations located within the area of effect; and
identify one or more unprotected users of the one or more users located within the area of effect by comparing the first, second, and third location data, the one or more unprotected users being located within the area of effect but outside of all of the one or more target locations.

11. The system of claim 10, wherein the one or more target locations are emergency shelters.

12. The system of claim 11, wherein the system identifies one or more users located in an emergency shelter and sends data of the one or more users located in the emergency shelter to a smartphone of an emergency responder.

13. The system of claim 10, wherein the personal security module, the processor, and the one or more location determination devices are configured to send natural disaster data to one or more affected users located within the area of effect.

14. The system of claim 10, wherein the personal security module, the processor, and the one or more location determination devices are configured to send notification data to emergency contacts of the one or more affected users.

15. The system of claim 10, wherein the personal security module, the processor, and the one or more location determination devices are configured to receive response data from the one or more unprotected users in response to prompting data sent by the system, the response data indicating whether or not the one or more unprotected users is safe.

16. The system of claim 15, wherein the personal security module, the processor, and the one or more location determination devices are configured to send status data for the one or more unprotected users to an emergency responder when the response data indicates that the one or more unprotected users is not safe.

17. The system of claim 10, wherein the personal security module, the processor, and the one or more location determination devices are configured to send the first location data, the second location data, and the third location data to an emergency agency.

18. A method for providing personal security, the method comprising:
receiving alert notification data at a personal security module, the alert notification data sent by a user via an input device;
retrieving location data of the user based on receiving the alert notification data;
retrieving location data of an emergency responder based on the location data of the user; and
establishing a communication link between the user and the emergency responder.

19. The method of claim 18, wherein the alert notification data is sent by the user via smart-phone and is a non-telephone-call transmission.

20. The method of claim 18, further comprising sending the location data of the user and the location data of the emergency responder to an emergency agency via a web portal.

21. The method of claim 18, wherein the communication link is a non-internet BLE mesh networking communication link.
